(19) United States
(12) Patent Application Publication
(10) Pub. No.: US 2006/0213538 A1
(43) Pub. Date: Sep. 28, 2006

(54) Semiconductor cleaning apparatus and semiconductor cleaning method

(76) Inventors: Kaori Umezawa, Kamakura-Shi (JP); Hiroshi Tomita, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/373,987

(22) Filed: Mar. 14, 2006

(30) Foreign Application Priority Data
Mar. 14, 2005 (JP) 2005-70711

(51) Int. Cl. B08B 7/04; B08B 3/00

(52) U.S. Cl. 134/18; 134/56 D; 134/113; 134/902

(57) ABSTRACT

A semiconductor cleaning apparatus according to the present invention comprises: a particle monitor which measures the number of particles in a processing liquid used in a rinse process after a semiconductor wafer is subjected to a cleaning process by means of the processing liquid; a specific resistance measuring unit which measures a specific resistance of a processing liquid used in the rinse process; and a control unit which determines an end point at which the rinse process is completed on the basis of the number of particles measured by the particle monitor and the specific resistance measured by the specific resistance measuring unit to end the rinse process.

### CROSS-REFERENCE TO RELATED APPLICATION

This application is based upon and claims the benefit of priority from prior Japanese Patent Application No. 2005-070711, filed on Mar. 14, 2005, the entire contents of which are incorporated herein by reference.

### BACKGROUND OF THE INVENTION

1. Field of the Invention

The present invention relates to a semiconductor cleaning apparatus and a semiconductor cleaning method which controls a rinse process performed after completion of a cleaning process of a semiconductor wafer.

2. Background Art

As a conventional semiconductor cleaning method, there is known a method in which a cleaning process for a semiconductor wafer is performed by trapping a cleaning chemical such as an SPM (Sulfuric Acid-hydrogen peroxide Mixture) or SC1 (ammonia-hydrogen peroxide mixture) in a cleaning tank, by sequentially overflowed the cleaning chemical in the cleaning tank by circularly supplying and by filtering the cleaning chemical at the circulation.

In the semiconductor cleaning method, a fixed quantity of cleaning chemical in the cleaning tank is taken out from a portion different from a circular supply portion for the cleaning chemical by means of an electric bellows pump, and particles mixed in the cleaning chemical are detected by a particle monitor. On the basis of the number of detected particles, a cleaning process, an exchange of cleaning chemicals, or an alarm for an abnormal state is displayed (for example, refer to the specification of Japanese Patent No. 3343651).

In such a conventional technique, for example, even though particles cannot be sufficiently removed after a cleaning process has completed, a rinse process is normally performed for a predetermined period of time regardless of a cleanliness factor of a wafer. For this reason, the next step in the wafer processing is disadvantageously started without satisfying a desired cleanliness factor. Furthermore, in the conventional technique, since the rinse process is ended regardless of a sticking state of the chemical to the wafer, the rinse process is performed for a period of time longer than a necessary period of time, or the rinse process is disadvantageously ended even though the chemical is not completely rinsed out.

### SUMMARY OF THE INVENTION

A semiconductor cleaning apparatus according to the present invention comprises: a particle monitor which measures the number of particles in a processing liquid used in a rinse process after a semiconductor wafer is subjected to a cleaning process by means of the processing liquid; a specific resistance measuring unit which measures a specific resistance of the processing liquid used in the rinse process; and a control unit which determines an end point at which the rinse process is completed on the basis of the number of particles measured by the particle monitor and the specific resistance measured by the specific resistance measuring unit to end the rinse process.

A semiconductor cleaning method according to the present invention comprises: starting a rinse process after a semiconductor wafer subjected to a cleaning process by means of a processing liquid; measuring number of particles in the processing liquid used in the rinse process; measuring a specific resistance of the processing liquid used in the rinse process; comparing the measured number of particles and the specific resistance with predetermined values, in order to respectively determine an end point at which the rinse process is completed; and ending the rinse process when it is determined that the rinse process is completed.

### BRIEF DESCRIPTION OF THE DRAWINGS

FIG. 1 shows a configuration of embodiment a main part of a semiconductor cleaning apparatus according to a first embodiment of the present invention;

FIG. 2 is a graph showing a relationship among a specific resistance of a processing liquid, conductivity, and processing time of a rinse process;

FIG. 3 is a graph showing the number of particles in a processing liquid and processing time of the rinse process;

FIG. 4 is a flow chart showing a semiconductor cleaning method according to the first embodiment of the present invention;

FIG. 5 is a graph showing a specific resistance of a processing liquid, and the number of particles, and processing time of the rinse process in the first embodiment of the present invention;

FIG. 6 is a graph showing a specific resistance of a processing liquid, the number of particles, and processing time of the rinse process in the first embodiment of the present invention;

FIG. 7 is a graph showing a specific resistance of a processing liquid, the number of particles, and processing time of the rinse process in the first embodiment of the present invention;

FIG. 8 shows a configuration of a main part of a semiconductor cleaning apparatus according to a second embodiment of the present invention; and

FIG. 9 is a flow chart showing a semiconductor cleaning method according to the second embodiment of the present invention.

### DETAILED DESCRIPTION

Embodiments of the present invention will be described below with reference to the accompanying drawings. The embodiments will explain cases in which a cleaning process and a rinse process for a semiconductor wafer are performed.

### First Embodiment

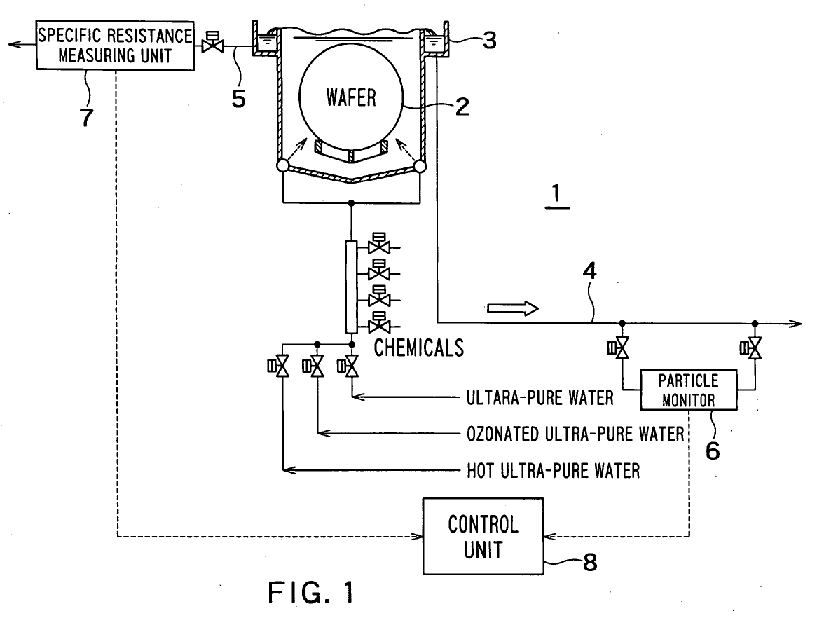

FIG. 1 shows a configuration of embodiment a main part of a semiconductor cleaning apparatus according to a first embodiment of the present invention.

A semiconductor cleaning apparatus 1 includes: a processing tank 3 to perform a cleaning process and a rinse process; a particle monitor 6 serving as a particle counting unit arranged in a bypass pipe of a first drain pipe 4 to measure the number of particles in processing liquid used in a rinse process; a specific resistance measuring unit 7 serving as a specific resistance measuring means arranged in a second drain pipe 5 to measure a specific resistance of the processing liquid used in the rinse process; and a control unit 8 serving as a control unit which determines an end point at which the rinse process is completed on the basis of a measurement result of the particle monitor 6 and a specific resistance measured by the specific resistance measuring unit 7. The cleaning process mentioned here includes a process of removing a resist, a process of removing particles or a metal impurity by alkaline or acid treatment or the like, a process of etching a film formed on a wafer, and the like.

In the semiconductor cleaning apparatus 1, the semiconductor wafer 2 is dipped in a processing liquid trapped in the processing tank 3 to perform a cleaning process with cleaning chemicals such as SC1. Thereafter, the semiconductor wafer 2 is subjected to a rinse process by ultra-pure water (UPW), and the processing liquid is sequentially overflowed from the processing tank 3, so that the processing liquid is discharged through the first drain pipe 4 and the second drain pipe 5. When the cleaning process is to be performed, valves are opened to supply chemicals, UPW, Ozonated UPW, and Hot UPW into the processing tank 3. When the rinse process is performed, the valve is controlled to supply only UPW into the processing tank 3.

The control unit 8 which controls the rinse process as described above is designed to determine completion of a desired rinse process when the number of particles measured by the particle monitor 6 is a predetermined value A or smaller and when a specific resistance measured by the specific resistance measuring unit 7 is a predetermined value B or higher.

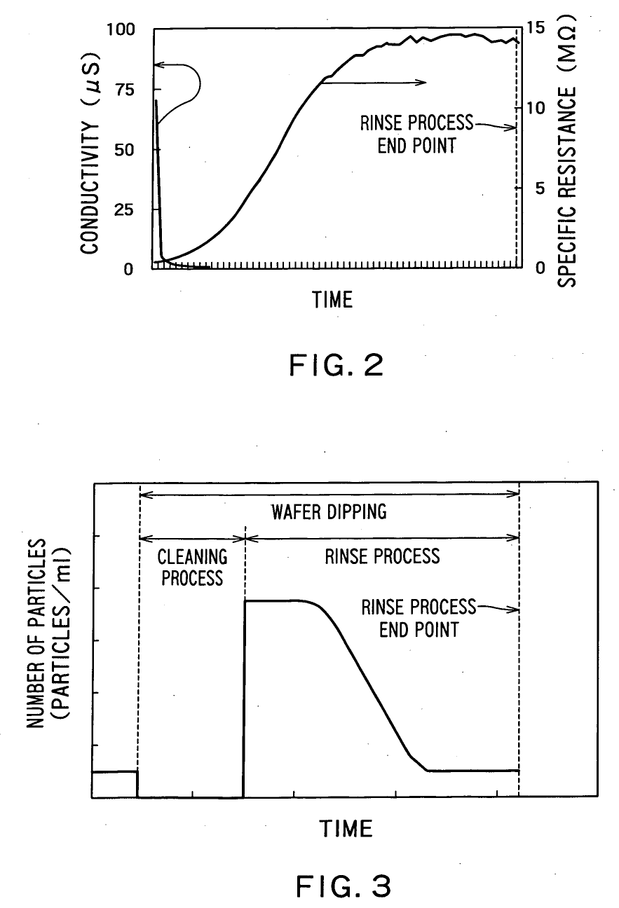

In this case, in order to cause the control unit 8 to determine an end point at which the desired rinse process is completed, the reason why the specific resistance of the processing liquid and the number of particles is detected will be described below. FIG. 2 is a graph showing a relationship among a specific resistance of a processing liquid, a conductivity of the processing liquid, and processing time of a rinse process. As shown in FIG. 2, immediately after the start of the rinse process, the specific resistance is low (high conductivity) because the chemicals remain in the processing liquid. However, it is understood that, as time for the rinse process progresses, the chemicals (ion components) are removed from the processing liquid to increase the resistance (decreases the conductivity) and to approximate the resistance to a constant value. For this reason, it is understood that the chemicals are sufficiently removed when the specific resistance of the processing liquid is the predetermined value B or higher.

FIG. 3 is a graph showing the number of particles in a processing liquid and processing time of a rinse process. As shown in FIG. 3, the following fast is understood. That is, even though a considerable number of particles remains in the processing liquid immediately after the rinse process has started, as time for the rinse process progresses, the particles are removed from the processing liquid to decrease the number of particles and to approximate the number of particles to a constant value (the number of particles in a processing liquid having a high cleanliness factor obtained before the cleaning process). For this reason, regardless of the cleanliness factor of the semiconductor wafer 2 obtained after the cleaning process, the particles could have sufficiently been removed by performing the rinse process for a predetermined period of time. When the number of particles in the processing liquid is the predetermined value A or smaller, it is understood that the desired cleanliness factor of the semiconductor wafer 2 will obtained. In FIG. 3, since the number of particles is not measured during the cleaning process of the semiconductor wafer 2, data is not displayed.

As described above, it is understood that by using the specific resistance of the processing liquid and the number of particles as criteria for determining an end point at which the rinse process is completed, it is possible to determine a desired cleanliness factor of a wafer and optimum processing time.

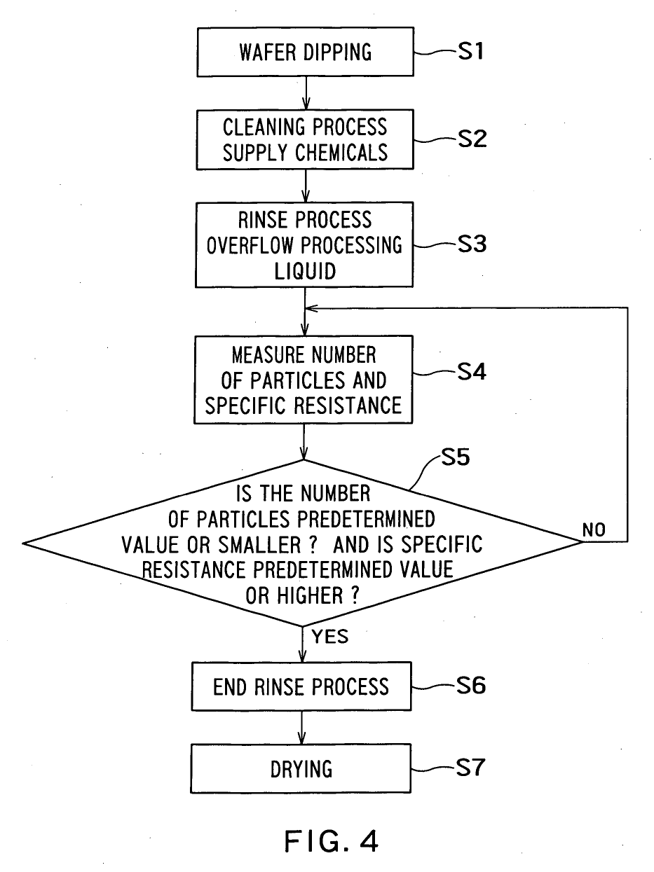

A semiconductor cleaning method using the semiconductor cleaning apparatus 1 will be described below with reference to FIGS. 4 to 7. FIG. 4 is a flow chart showing steps in a semiconductor cleaning method according to the first embodiment of the present invention.

First, the semiconductor wafer 2 is dipped in a processing liquid in the processing tank 3 to perform a cleaning process (step S1). Valves of the semiconductor cleaning apparatus 1 is opened to supply chemicals, UPW, ozonated UPW, and Hot UPW into the processing tank 3 (step S2).

After a predetermined cleaning process, a rinse process to remove the chemicals is started, the valves are controlled to supply the UPW into the processing tank 3, in order to overflow sequentially the processing liquid from the processing tank 3 (step S3).

The number of particles in the processing liquid used in the rinse process is measured by the particle monitor 6, and a specific resistance of the processing liquid used in the rinse process is measured by the specific resistance measuring unit 7 (step S4).

The control unit 8 compares the measured number of particles and the measured specific resistance with predetermined values A and B, respectively, to determine an end point at which the rinse process is completed (step S5). More specifically, in step S5, the control unit 8 determines that a desired rinse process is completed when the number of particles is the predetermined value A or smaller and when the specific resistance is the predetermined value B or higher. On the other hand, when the number of particles is larger than the predetermined value A, or when the specific resistance is lower than the predetermined value B, the control unit 8 determines that the desired rinse process is not completed. Returning to step S4, the measurements of the number of particles and the specific resistance are continued.

When the control unit 8 determines that the rinse process is completed in step S5, a wafer conveying request command becomes enable (step S6), and the wafer is conveyed from the processing tank to a drying unit to dry the wafer (step S7). The next step is started.

With the above steps, semiconductor cleaning by the semiconductor cleaning apparatus 1 is completed.

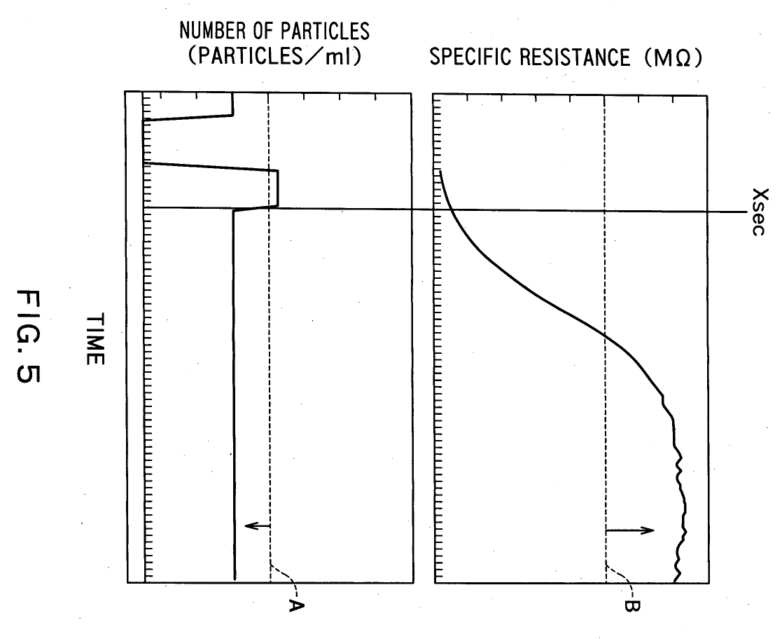

A relationship among the specific resistance of the processing liquid, the number of particles in the processing liquid, and the predetermined values A and B serving as criteria for determination will be described below. FIGS. 5 to 7 are graphs showing specific resistances of a processing liquid, the numbers of particles in the processing liquid, processing time of a rinse process in the first embodiment of the present invention. Reference values (predetermined values A and B) with respect to the numbers of particles and the specific resistances are indicated by dotted lines to determine the completion of the rinse process in each of the drawings.

In FIG. 5, at elapsed time x of the rinse process, the specific resistance is lower than the predetermined value B, and the number of particles is smaller than the predetermined value A. For this reason, the specific resistance does not satisfy the criterion for determination. Therefore, the control unit 8 determines that a desired rinse process is not completed.

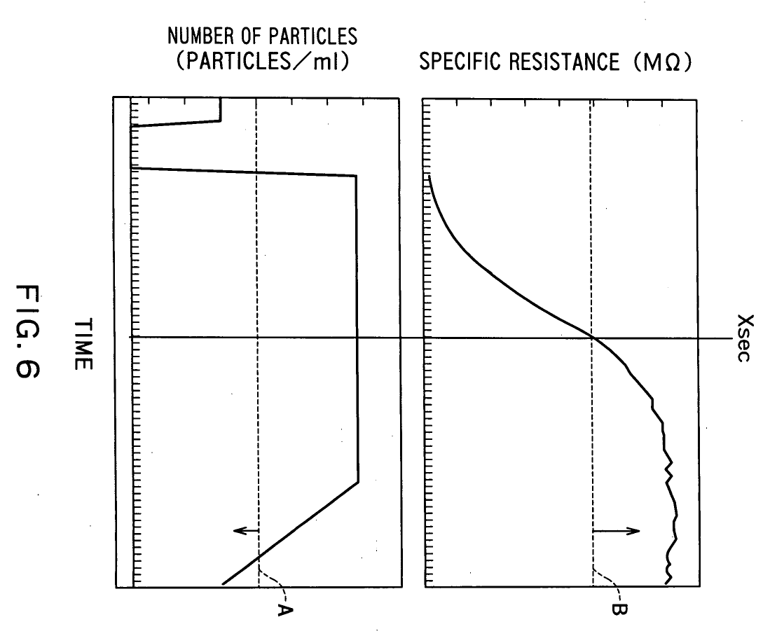

In FIG. 6, at elapsed time x of the rinse process, the specific resistance is just the predetermined value B, and the number of particles is larger than the predetermined value A. For this reason, the number of particles does not satisfy the criterion for determination. Therefore, the control unit 8 determines that a desired rinse process is not completed.

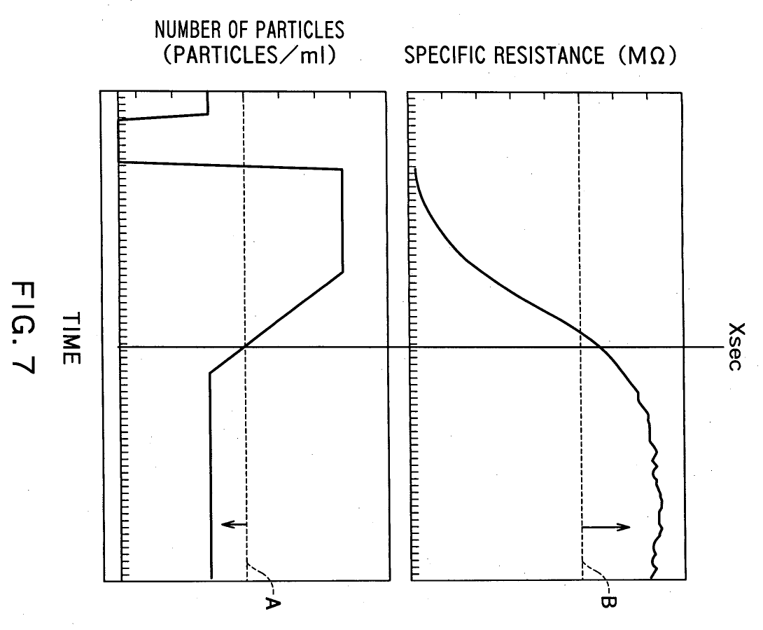

In FIG. 7, at elapsed time x of the rinse process, the specific resistance is higher than the predetermined value B, and the number of particles is just the predetermined value A. For this reason, both the specific resistance and the number of particles satisfy the criterions for determination. Therefore, the control unit 8 determines that a desired rinse process is completed.

The specific resistance measuring unit 7 is not necessarily installed on the bypass of the first drain pipe 4 and may be installed at such a position that a processing liquid used in the rinse process can be measured. Similarly, the specific resistance measuring unit 7 is not necessarily installed on the bypass of the second drain pipe 5 and may be installed at such a position that a processing liquid used in the rinse process can be measured.

When the specific resistance of the processing liquid used in the rinse process is the predetermined value B or higher, and when the number of particles is larger than the predetermined value A, the measurement of the specific resistance which satisfies the criterion for determining completion of the rinse process may be ended, and the measurement of only the number of particles which does not satisfy the criterion for determination may be continued. Similarly, when the number of particles in the processing liquid used in the rinse process is the predetermined value A or smaller, and when the specific resistance is the predetermined value B or lower, the measurement of the number of particles which satisfy the criterion for determining completion of the rinse process may be ended, and the measurement of only the specific resistance which does not satisfy the criterion for determination may be continued.

In this manner, by the semiconductor cleaning apparatus and the semiconductor cleaning method according to the embodiment, the number of particles and the specific resistance of a processing liquid used in a rinse process are compared with the predetermined values A and B to determine an end point at which the rinse process is completed, and the rinse process is ended. For this reason, processing time of the rinse process can be optimized while maintaining a desired cleanliness factor of a wafer regardless of a semiconductor wafer the cleaning process of which is completed.

### Second Embodiment

As described above, according to the configuration of the control unit 8 determines an end point of a rinse process on the basis of the number of particles and the specific resistance of a processing liquid used in the rinse process, the number of particles being measured by the particle monitor 6. The second embodiment will describe a configuration in which the control unit 8 determines an end point of a rinse process on the basis of the specific resistance and a difference between the first number of particles in a processing liquid used in the rinse process and the second number of particles in the processing liquid having a large cleanliness factor obtained before a cleaning process (i.e., a relative change of the number of particles).

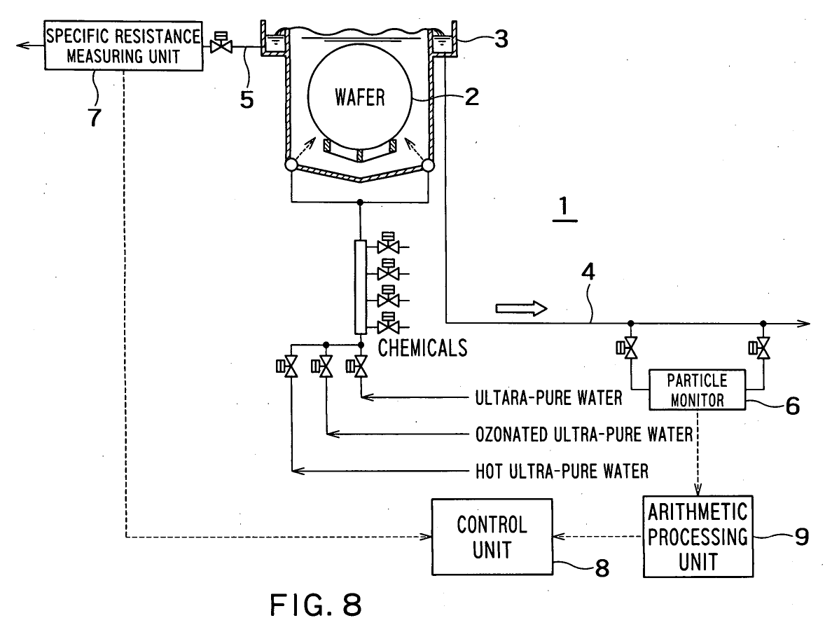

FIG. 8 shows a configuration of a main part of a semiconductor cleaning apparatus according to a second embodiment of the present invention. In this embodiment, a particle monitor 6 is designed to further measure the number of particles in the processing liquid having a high cleanliness factor obtained before a semiconductor wafer 2 is subjected to a cleaning process. A semiconductor cleaning apparatus 1 further includes an arithmetic processing unit 9 which arithmetically calculates a difference between the first number of particles in the processing liquid obtained before the semiconductor wafer 2 is subjected to the cleaning process and the second number of particles in the processing liquid used in a rinse process, the first and second number of particles being measured by the particle monitor 6.

In this case, the control unit 8 is designed to determine an end point at which the rinse process is completed and to end the rinse process, on the basis of a calculation result from the arithmetic processing unit 9 and a specific resistance measured by a specific resistance measuring unit 7. More specifically, when the difference between the numbers of particles calculated by the arithmetic processing unit 9 is a predetermined value A1 or smaller, and when the specific resistance is a predetermined value B or higher, the control unit 8 determines completion of the rinse process.

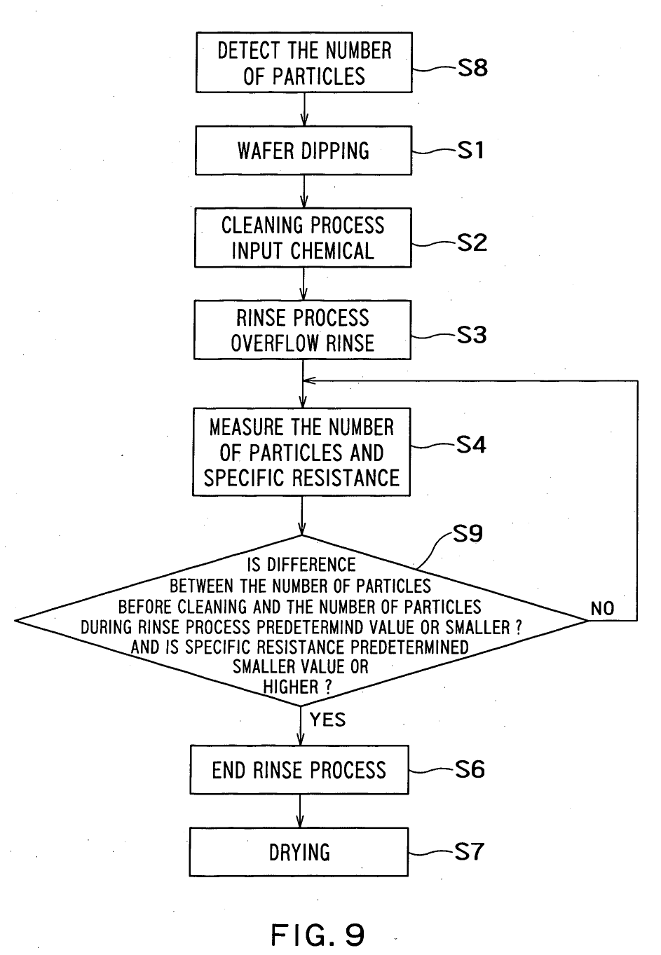

A semiconductor cleaning method using the semiconductor cleaning apparatus 1 will be described below. FIG. 9 is a flow chart showing a semiconductor cleaning method according to the second embodiment of the present invention.

As shown in FIG. 9, the semiconductor cleaning method according to the embodiment further includes measuring the number of particles in a processing liquid obtained before the semiconductor wafer 2 is subjected to a cleaning process (step S8).

To determine an end point at which the rinse process is completed (step S9), the control unit 8 determines the end point at which the rinse process is completed on the basis of a difference between the first number of particles in a processing liquid obtained before a cleaning process and the second number of particles in a processing liquid used in a rinse process and a measurement result of a specific resistance. More specifically, in step S9, when the difference between the first number of particles in the processing liquid obtained before the cleaning process and the second number of particles in the processing liquid used in the rinse process is a predetermined value A1 or smaller, and when the specific resistance of the processing liquid is a predetermined value B or higher, completion of the rinse process is determined. On the other hand, when the difference between the numbers of particles is larger than the predetermined value A1, or when the specific resistance is lower than the predetermined value B, the control unit 8 determines that a desired rinse process is not completed and returns to step S4 to continue the measurements of the numbers of particles and the specific resistance.

When it is determined in step S9 that the rinse process is completed, as in the first embodiment, the rinse process is ended (step S6), the semiconductor wafer 2 is dried (step S7), and the next process is started.

In the embodiment, the first number of particles in the processing liquid obtained before the cleaning process of the semiconductor wafer is performed, and the difference between the first number of particles and the second number of particles in the processing liquid used in the rinse process is calculated to determine an end point of the rinse process. However, a first number of particles in the processing liquid obtained after the cleaning process may be measured, and a difference between the first number of particles and the second number of particles in the processing liquid obtained after the rinse process may be calculated to determine an end point of the rinse process. Similarly, a first number of particles in the processing liquid obtained immediately after the rinse process is started may be measured, and a difference between the first number of particles and the second number of particles in the processing liquid obtained after the rinse process is continuously performed may be calculated to determine an end point of the rinse process.

As described above, by the semiconductor cleaning apparatus and the semiconductor cleaning method according to the embodiment, the difference between the first number of particles in the processing liquid used in the rinse process and the second number of particles in the processing liquid obtained before the cleaning process and the specific resistance are compared with the predetermined values A1 and B, respectively, to determine an end point at which the rinse process is completed, and the rinse process is ended. For this reason, processing time of the rinse process can be optimized while maintaining a desired cleanliness factor of a semiconductor wafer regardless of the state of the semiconductor wafer after the cleaning process.

The first and second embodiments mainly explain the case in which the specific resistance of the processing liquid is measured to determine an end point of a rinse process. However, the end point of the rinse process may be determined on the basis of a conductivity which is an inverse number of a specific resistance.

In the first and second embodiments, a cleaning process and a rinse process are performed in a single processing tank. However, even though a cleaning or etching process and a rinse process are performed in a circulation tank and a processing tank, respectively, the present invention can be applied, and the same effect as described above can be obtained as a matter of course.

In the first and second embodiments, a cleaning process and a rinse process are performed for some wafers. However, even though a cleaning process and a rinse process are performed for one wafer, the present invention can be applied, and the same effect as described above can be obtained as a matter of course.

What is claimed is:

1. A semiconductor cleaning apparatus comprising:
a particle monitor which measures the number of particles in a processing liquid used in a rinse process after a semiconductor wafer is subjected to a cleaning process by means of the processing liquid;
a specific resistance measuring unit which measures a specific resistance of the processing liquid used in the rinse process; and
a control unit which determines an end point at which the rinse process is completed on the basis of the number of particles measured by the particle monitor and the specific resistance measured by the specific resistance measuring unit to end the rinse process.

2. The semiconductor cleaning apparatus according to claim 1, wherein
the control unit determines completion of the rinse process when the measured number of particles is a predetermined value or smaller and the specific resistance is a predetermined value or higher.

3. The semiconductor cleaning apparatus according to claim 1, wherein
the particle monitor further measures first number of particles in the processing liquid obtained before the semiconductor wafer is subjected to the cleaning process,
the semiconductor cleaning apparatus further comprises an arithmetic processing unit which calculates a difference between the first number of particles in the processing liquid obtained by the particle monitor before the semiconductor wafer is subjected to the cleaning process and second number of particles in the processing liquid used in the rinse process, and
the control unit determines an end point at which the rinse process is completed on the basis of a calculation result of the arithmetic processing unit and the specific resistance measured by the specific resistance measuring unit to end the rinse process.

4. The semiconductor cleaning apparatus according to claim 3, wherein
the control unit determines completion of the rinse process when the difference between the first and the second numbers of particles calculated by the arithmetic processing unit is the predetermined value or smaller and the specific resistance is the predetermined value or higher.

5. The semiconductor cleaning apparatus according to claim 1, wherein
the particle monitor further measures first number of particles in the processing liquid obtained after the semiconductor wafer is subjected to the cleaning process,
the semiconductor cleaning apparatus further comprises an arithmetic processing unit which calculates a difference between the first number of particles in the processing liquid obtained by the particle monitor after the semiconductor wafer has been subjected to the cleaning process and second number of particles in the processing liquid used in the rinse process, and
the control unit determines an end point at which the rinse process is completed on the basis of a calculation result of the arithmetic processing unit and the specific resistance measured by the specific resistance measuring unit to end the rinse process.

6. The semiconductor cleaning apparatus according to claim 5, wherein
the control unit determines completion of the rinse process when the difference between the first and the second numbers of particles calculated by the arithmetic processing unit is the predetermined value or smaller and the specific resistance is the predetermined value or higher.

7. The semiconductor cleaning apparatus according to claim 1, wherein
the particle monitor further measures first number of particles in the processing liquid obtained immediately after the rinse process is started,
the semiconductor cleaning apparatus further comprises an arithmetic processing unit which calculates a difference between the first number of particles in the processing liquid obtained by the particle monitor immediately after rinse process is started and second number of particles in the processing liquid obtained after the rinse process is continuously performed, and
the control unit determines an end point at which the rinse process is completed on the basis of a calculation result of the arithmetic processing unit and the specific resistance measured by the specific resistance measuring unit to end the rinse process.

8. The semiconductor cleaning apparatus according to claim 5, wherein
the control unit determines completion of the rinse process when the difference between the first and the second numbers of particles calculated by the arithmetic processing unit is the predetermined value or smaller and the specific resistance is the predetermined value or higher.

9. The semiconductor cleaning according to claim 1, wherein the cleaning process and the rinse process of the semiconductor wafer are performed in a single processing tank.

10. A semiconductor cleaning method comprising:
starting a rinse process after a semiconductor wafer subjected to a cleaning process by means of a processing liquid;
measuring number of particles in the processing liquid used in the rinse process;
measuring a specific resistance of the processing liquid used in the rinse process;
comparing the measured number of particles and the specific resistance with predetermined values, in order to respectively determine an end point at which the rinse process is completed; and
ending the rinse process when it is determined that the rinse process is completed.

11. The semiconductor cleaning method according to claim 10, wherein
when the end point at which completion of the rinse process is determined, it is determined that the rinse process is completed when the number of particles is the predetermined value or smaller and the specific resistance is the predetermined value or higher.

12. The semiconductor cleaning method according to claim 10, wherein
first number of particles in the processing liquid obtained before the cleaning process of the semiconductor wafer is performed is further measured, and
when the end point at which completion of the rinse process is determined, the end point at which completion of the rinse process is determined on the basis of a difference between the first number of particles in the processing liquid obtained before the cleaning process and second number of particles in the processing liquid used in the rinse process and the specific resistance.

13. The semiconductor cleaning method according to claim 12, wherein
when the end point at which completion of the rinse process is determined, it is determined that the rinse process is completed when a difference between the first number of particles in the processing liquid obtained before the cleaning process and the second number of particles in the processing liquid used in the rinse process is the predetermined value or smaller and the specific resistance is the predetermined value or higher.

14. The semiconductor cleaning method according to claim 10, wherein
first number of particles in the processing liquid obtained after the semiconductor wafer is subjected to the cleaning process is further measured, and
when the end point at which completion of the rinse process is determined, the end point at which completion of the rinse process is determined on the basis of a difference between the first number of particles in the processing liquid obtained after the semiconductor wafer is subjected to the cleaning process and second number of particles in the processing liquid used in the rinse process and the specific resistance.

15. The semiconductor cleaning method according to claim 14, wherein
when the end point at which completion of the rinse process is determined, it is determined that the rinse process is completed when a difference between the first number of particles in the processing liquid obtained after the semiconductor wafer is subjected to the cleaning process and the second number of particles in the processing liquid used in the rinse process is the predetermined value or smaller and the specific resistance is the predetermined value or higher.

16. The semiconductor cleaning method according to claim 10, wherein
first number of particles in the processing liquid obtained immediately after the rinse process is started is further measured, and
when the end point at which completion of the rinse process is determined, the end point at which completion of the rinse process is determined on the basis of a difference between the first number of particles in the processing liquid obtained immediately after the rinse process is started and second number of particles in the processing liquid obtained after the rinse process is continuously performed and the specific resistance.

17. The semiconductor cleaning method according to claim 16, wherein
when the end point at which completion of the rinse process is determined, it is determined that the rinse process is completed when a difference between the first number of particles in the processing liquid obtained after the semiconductor wafer is subjected to the cleaning process and the second number of particles in the processing liquid used in the rinse process is the predetermined value or smaller and the specific resistance is the predetermined value or higher.

18. The semiconductor cleaning according to claim 10, wherein the cleaning process and the rinse process of the semiconductor wafer are performed in a single processing tank.
